(19) United States
(12) Patent Application Publication
(10) Pub. No.: US 2021/0209392 A1
(43) Pub. Date: Jul. 8, 2021

(54) Image Processing Method and Device, and Storage Medium

(71) Applicant: Beijing Sensetime Technology Development Co., Ltd., Beijing (CN)

(72) Inventors: Jiangmiao Pang, Beijing (CN); Kai Chen, Beijing (CN); Jianping Shi, Beijing (CN); Dahua Lin, Beijing (CN); Wanli Ouyang, Beijing (CN); Huajun Feng, Beijing (CN)

(73) Assignee: Beijing Sensetime Technology Development Co., Ltd., Beijing (CN)

(21) Appl. No.: 17/209,384

(22) Filed: Mar. 23, 2021

Related U.S. Application Data
(63) Continuation of application No. PCT/CN2019/121696, filed on Nov. 28, 2019.

(30) Foreign Application Priority Data
Feb. 1, 2019 (CN) 201910103611.1

(51) Int. Cl. G06K 9/20; G06K 9/62; G06K 9/46; G06T 7/73

(52) U.S. Cl. CPC G06K 9/2054; G06K 9/6256; G06K 9/628; G06K 9/46; G06K 9/6232; G06N 3/08; G06T 7/73; G06K 9/629; G06K 2209/21; G06T 2207/20081; G06T 2207/20084; G06K 9/6262

(57) ABSTRACT

The present disclosure relates an image processing method and device, and a storage medium. The method comprises: performing a feature equalization processing on a sample image by an equalization subnetwork of a detection network to obtain an equalized feature image of the sample image; performing a target detection processing on the equalized feature image by a detection subnetwork of the detection network to obtain predicted regions of a target object in the equalized feature image; determining an intersection-over-union of each of the predicted regions respectively; sampling the plurality of predicted regions according to the intersection-over-union of each predicted region to obtain a target region; and training the detection network according to the target region and a labeled region. The systems and techniques disclosed here can reduce information loss and improve the training effect and training efficiency.

### CROSS REFERENCE TO RELATED APPLICATIONS

The present disclosure is a continuation of and claims priority under 35 U.S.C. 120 to PCT Application. No. PCT/CN2019/121696, filed on Nov. 28, 2019, which claims priority to Chinese Patent Application No. 201910103611.1, filed to CNIPA on Feb. 1, 2019 and entitled “IMAGE PROCESSING METHOD AND DEVICE, ELECTRONIC APPARATUS, AND STORAGE MEDIUM.” All the above-referenced priority documents are incorporated herein by reference in their entireties.

### TECHNICAL FIELD

The present disclosure relates to the field of computer technology, and in particular to an image processing method and device, an electronic apparatus, and a storage medium.

### BACKGROUND

In related art, in the process of neural network training, difficult samples and simple samples are different in importance to neural network training. Difficult samples can acquire more information during the training process, which makes the training process more efficient and the training effect better. However, in a large number of samples, the number of simple samples is larger. In addition, during the training process, each level of the neural network has its own emphasis on the extracted features.

### SUMMARY

The present disclosure proposes an image processing method and device, an electronic apparatus, and a storage medium.

According to one aspect of the present disclosure, provided is an image processing method characterized by comprising:

performing a feature equalization processing on a sample image by an equalization subnetwork of a detection network to obtain an equalized feature image of the sample image, the detection network including the equalization subnetwork and a detection subnetwork;

performing a target detection processing on the equalized feature image by the detection subnetwork to obtain a plurality of predicted regions of a target object in the equalized feature image;

determining an intersection-over-union of each of the plurality of predicted regions respectively, wherein the intersection-over-union is an area ratio of an overlapping region to a merged region of a predicted region of the target object and the corresponding labeled region in the sample image;

sampling the plurality of predicted regions according to the intersection-over-union of each of the predicted regions to obtain a target region; and

training the detection network according to the target region and the labeled region.

According to the image processing method of the embodiments of the present disclosure, the feature equalization process is performed on the target sample image, which can avoid the information loss and improve the training effect. And, the target region can be extracted according to the intersection-over-union of the predicted region, which can increase the probability of extracting the predicted region whose determining process is difficult, enhance the training efficiency and improve the training effect.

In a possible implementation, sampling the plurality of predicted regions according to the intersection-over-union of each of the predicted regions to obtain the target region comprises:

performing a classification processing on the plurality of predicted regions according to the intersection-over-union of each of the predicted regions to obtain a plurality of categories of predicted regions; and

performing a sampling processing on the predicted regions of each category respectively to obtain the target region.

By this way, it is possible to classify the predicted regions by the intersection-over-union, and sample the predicted regions of each category, which can increase the probability of extracting the predicted regions with higher intersection-over-unions, increase the proportion of the predicted region whose determining process is difficult in the target region, and improving the training efficiency.

In a possible implementation, performing the feature equalization processing on the sample image by the equalization subnetwork of the detection network to obtain the equalized feature image comprises:

performing a feature extraction processing on the sample image to obtain a plurality of first feature maps, wherein a resolution of at least one of the plurality of first feature maps is different from those of other first feature maps;

performing an equalization processing on the plurality of first feature maps to obtain a second feature map; and

obtaining a plurality of equalized feature images according to the second feature map and the plurality of first feature maps.

In a possible implementation, performing the equalization processing on the plurality of first feature maps to obtain the second feature map comprises:

performing a scaling processing on the plurality of first feature maps respectively to obtain a plurality of third feature maps with preset resolutions;

performing an average processing on the plurality of third feature maps to obtain a fourth feature map; and

performing a feature extraction processing on the fourth feature map to obtain the second feature map.

In a possible implementation, obtaining the plurality of equalized feature images according to the second feature map and the plurality of first feature maps comprises:

performing a scaling processing on the second feature map to obtain a fifth feature map corresponding to the each first feature map respectively, wherein the first feature map has the same resolution as that of the corresponding fifth feature map; and

performing a residual connection on the each first feature map and the corresponding fifth feature map to obtain the equalized feature image.

By this way, it is possible to obtain the second feature map of feature equalization by the equalization processing, and obtain an equalized feature map by a residual connection, which can reduce the information loss and improve the training effect.

In a possible implementation, training the detection network according to the target region and the labeled region comprises:

determining an identification loss and a location loss of the detection network according to the target region and the labeled region;

adjusting network parameters of the detection network according to the identification loss and the location loss; and

obtaining the trained detection network when training conditions are satisfied.

In a possible implementation, determining the identification loss and the location loss of the detection network according to the target region and the labeled region comprises:

determining a position error between the target region and the labeled region; and

determining the location loss according to the position error when the position error is less than a preset threshold.

In a possible implementation, determining the identification loss and the location loss of the detection network according to the target region and the labeled region comprises:

determining a position error between the target region and the labeled region; and

determining the location loss according to a preset value when the position error is larger than or equal to a preset threshold.

By this way, it is possible to improve the gradient of the location loss, improve the training efficiency, and improve the goodness-of-fit of the detection network when the prediction on the target object is correct. And when the prediction on the target object is incorrect, it is possible to reduce the gradient of the location loss and reduce the influence of location loss on the training process, so as to accelerate the convergence of location loss and improve the training efficiency.

According to another aspect of the present disclosure, provided is an image processing method comprising:

inputting an image to be detected into the detection network trained by the image processing method for processing, so as to obtain a position information of the target object.

According to another aspect of the present disclosure, provided is an image processing device characterized by comprising:

an equalization module configured to perform a feature equalization processing on a sample image by an equalization subnetwork of a detection network to obtain an equalized feature image of the sample image, the detection network including the equalization subnetwork and a detection subnetwork;

a detection module configured to perform a target detection processing on the equalized feature image by the detection subnetwork to obtain a plurality of predicted regions of a target object in the equalized feature image;

a determination module configured to determine an intersection-over-union of each of the plurality of predicted regions respectively, wherein the intersection-over-union is an area ratio of an overlapping region to a merged region of a predicted region of the target object and the corresponding labeled region in the sample image;

a sampling module configured to sample the plurality of predicted regions according to the intersection-over-union of each of the predicted regions to obtain a target region; and

a training module configured to train the detection network according to the target region and the labeled region.

In a possible implementation, the sampling module is further configured to:

perform a classification processing on the plurality of predicted regions according to the intersection-over-union of each of the predicted regions to obtain a plurality of categories of predicted regions; and

perform a sampling processing on the predicted regions of each category respectively to obtain the target region.

In a possible implementation, the equalization module is further configured to:

perform a feature extraction processing on the sample image to obtain a plurality of first feature maps, wherein a resolution of at least one of the plurality of first feature maps is different from those of other first feature maps;

perform an equalization processing on the plurality of first feature maps to obtain a second feature map; and

obtain a plurality of equalized feature images according to the second feature map and the plurality of first feature maps.

In a possible implementation, the equalization module is further configured to:

perform a scaling processing on the plurality of first feature maps respectively to obtain a plurality of third feature maps with preset resolutions;

perform an average processing on the plurality of third feature maps to obtain a fourth feature map; and

perform a feature extraction processing on the fourth feature map to obtain the second feature map.

In a possible implementation, the equalization module is further configured to:

perform a scaling processing on the second feature map to obtain a fifth feature map corresponding to the each first feature map respectively, wherein the first feature map has the same resolution as that of the corresponding fifth feature map; and

perform a residual connection on the each first feature map and the corresponding fifth feature map to obtain the equalized feature image.

In a possible implementation, the training module is further configured to:

determine an identification loss and a location loss of the detection network according to the target region and the labeled region;

adjust network parameters of the detection network according to the identification loss and the location loss; and

obtain the trained detection network when training conditions are satisfied.

In a possible implementation, the training module is further configured to:

determine a position error between the target region and the labeled region; and

determine the location loss according to the position error when the position error is less than a preset threshold.

In a possible implementation, the training module is further configured to:

determine a position error between the target region and the labeled region; and

determine the location loss according to a preset value when the position error is larger than or equal to a preset threshold.

According to another aspect of the present disclosure, provided is an image processing device comprising:

an obtaining module configured to input an image to be detected into the detection network trained by the image processing device for processing, so as to obtain a position information of the target object.

According to one aspect of the present disclosure, provided is an electronic apparatus characterized by comprising:

a processor; and

a memory configured to store processor executable instructions,

wherein the processor is configured to execute the above image processing method.

According to one aspect of the present disclosure, provided is a computer readable storage medium having computer program instructions stored thereon, the computer program instructions, when executed by a processor, implement the above image processing method.

According to one aspect of the present disclosure, provided is a computer program comprising computer readable codes, characterized in that when the computer readable codes is run on an electronic apparatus, a processor in the electronic apparatus executes instructions for executing the above image processing method.

According to the image processing method of the embodiments of the present disclosure, it is possible to obtain the second feature map of feature equalization by the equalization processing and obtain the equalized feature map by the residual connection, which can reduce the information loss, improve the training effect, and improve the detection accuracy of the detection network. It is possible to classify the predicted regions by the intersection-over-union and sample the predicted regions of each category, which can improve the probability of extracting the predicted regions with higher intersection-over-unions, improve the proportion of predicted region whose determining process is difficult in the predicted regions, improve the training efficiency, and reducing the memory consumption and resource occupation. Further, it is possible to improve the gradient of location loss, improve the training efficiency, and improve the goodness-of-fit of the detection network when the prediction on the target object is correct, and when the prediction on the target object is incorrect, it is possible to reduce the gradient of location loss and reduce the influence of location loss on the training process so as to accelerate the convergence of location loss and improve the training efficiency.

It should be understood that the foregoing general description and the following detailed description are merely illustrative and explanatory, rather than limiting the present disclosure.

Other features and aspects of the present disclosure will become apparent from the following detailed description of the exemplary embodiments with reference to the accompanying drawings.

### BRIEF DESCRIPTION OF THE DRAWINGS

The accompanying drawings, which are incorporated herein and constitute a part of the specification, illustrate embodiments in conformity with the present disclosure and, together with the specification, serve to explain the technical solutions of the present disclosure.

FIG. 1 shows a flowchart of an image processing method according to embodiments of the present disclosure;

FIG. 2 shows a schematic diagram of an intersection-over-union of a predicted region according to embodiments of the present disclosure;

FIG. 3 shows a schematic diagram of an application of an image processing method according to embodiments of the present disclosure;

FIG. 4 shows a block diagram of an image processing device according to embodiments of the present disclosure;

FIG. 5 shows a block diagram of an electronic apparatus according to embodiments of the present disclosure;

FIG. 6 shows a block diagram of an electronic apparatus according to embodiments of the present disclosure.

### DETAILED DESCRIPTION

Various exemplary embodiments, features and aspects of the present disclosure will be described in detail hereinafter with reference to the accompanying drawings. In the drawings, same reference numerals refer to same or similar elements. Although various aspects of the embodiments are shown in the drawings, the drawings are not necessarily to drawn to scale unless otherwise specified.

The special term “exemplary” here means “used as an example, an embodiment, and an illustration”. Any embodiment described herein as “exemplary” need not be construed as superior or better than other embodiments.

The term “and/or” herein is merely an association relationship describing associated objects, which means there may be three relationships. For example, A and/or B may indicate three cases of A alone, A and B together, and B alone. In addition, the term “at least one” herein means any one of multiple or any combination of at least two of the multiple. For example, including at least one of A, B, C may indicate including any one or more elements selected from a set consisting of A, B, and C.

In addition, in the following detailed embodiments, numerous specific details are set forth in order to better explain the present disclosure. Those skilled in the art will understand that, the present disclosure may also be practiced without certain specific details. In some instances, those methods, means, elements, and circuits well known to those skilled in the art are not described in detail in order to highlight the gist of the present disclosure.

FIG. 1 shows a flowchart of an image processing method according to embodiments of the present disclosure. As shown in FIG. 1, the method comprises:

in step S11, performing a feature equalization processing on a sample image by an equalization subnetwork of a detection network to obtain an equalized feature image of the sample image, the detection network including the equalization subnetwork and a detection subnetwork;

in step S12, performing a target detection processing on the equalized feature image by the detection subnetwork to obtain a plurality of predicted regions of a target object in the equalized feature image;

in step S13, determining an intersection-over-union of each of the plurality of predicted regions respectively, wherein the intersection-over-union is an area ratio of an overlapping region to a merged region of a predicted region of the target object and a corresponding labeled region in the sample image;

in step S14, sampling the plurality of predicted regions according to the intersection-over-union of the each predicted region to obtain a target region; and

in step S15, training the detection network according to the target region and the labeled region.

According to the image processing method of embodiments of the present disclosure, the feature equalization processing is performed on the target sample image, which can avoid the information loss and improve the training effect. And, the target region can be extracted according to the intersection-over-union of the predicted region, which can improve the probability of extracting the predicted region whose determining process is difficult, enhance the training efficiency and improve the training effect.

In a possible implementation, the image processing method may be executed by a terminal apparatus. The terminal apparatus may be a User Equipment (UE), a mobile apparatus, a user terminal, a terminal, a cellular phone, a cordless telephone, a Personal Digital Assistant (PDA), a handheld apparatus, a computing apparatus, an in-vehicle apparatus, a wearable apparatus, and so on. The method may be implemented by invoking, by a processor, a computer readable instruction stored in a memory. Alternatively, the image processing method is executed by a server.

In a possible implementation, the detection network may be a neural network such as a convolutional neural network, and there is no limitation on the type of the detection network in the present disclosure. The detection network may include an equalization subnetwork and a detection subnetwork. A feature map of the sample image can be extracted by each level of the equalization subnetwork of the detection network, and features of the feature map extracted by each level can be equalized by the feature equalization processing, so as to reduce the information loss and improve the training effect.

In a possible implementation, step S11 may include: performing a feature extraction processing on the sample image to obtain a plurality of first feature maps, wherein a resolution of at least one of the plurality of first feature maps is different from those of other first feature maps; performing an equalization processing on the plurality of first feature maps to obtain a second feature map; and obtaining a plurality of equalized feature images according to the second feature map and the plurality of first feature maps.

In a possible implementation, the feature equalization processing can be performed by using the equalization subnetwork. In an example, the feature extraction processing can be performed on the target sample image by respectively using a plurality of convolution layers of the equalization subnetwork to obtain a plurality of first feature maps. In the first feature maps, the resolution of at least one first feature map is different from those of other first feature maps, for example, resolutions of the plurality of first feature maps are mutually different. In an example, a first convolutional layer performs the feature extraction processing on the target sample image to obtain the 1st first feature map; and then a second convolutional layer performs the feature extraction processing on the 1st first feature map to obtain the 2nd first feature map; . . . A plurality of first feature maps can be obtained in this way, the plurality of first feature maps are acquired respectively by convolutional layers at different levels, and the convolutional layer at each level has its own emphasis on features in the first feature map.

In a possible implementation, performing the equalization processing on the plurality of first feature maps to obtain the second feature map includes: performing a scaling processing on the plurality of first feature maps respectively to obtain a plurality of third feature maps with preset resolutions; and performing an average processing on the plurality of third feature maps to obtain a fourth feature map; and performing a feature extraction processing on the fourth feature map to obtain the second feature map.

In a possible implementation, the resolutions of the plurality of first feature maps may have mutually different resolutions, such as 640×480, 800×600, 1024×768, 1600×1200. A scaling processing can be performed on each of the first feature maps respectively to obtain a third image with a preset resolution. The preset resolution may be an average value of the resolutions of the plurality of first feature maps or another set value, and there is no limitation on the preset resolution in the present disclosure. A scaling processing can be performed on the first feature map to obtain a third feature map with a preset resolution. In an example, an up-sampling processing such as interpolation can be performed on the first feature map with a resolution lower than the preset resolution to improve the resolution and obtain a third feature map with the preset resolution. A down-sampling processing such as pooling processing can be performed on the first feature map with a resolution higher than the preset resolution to obtain a third feature map with the preset resolution. There is no limitation on the method of scaling in the present disclosure.

In a possible implementation, an average processing can be performed on a plurality of third feature maps. In an example, resolutions of the plurality of third feature maps are the same, and all are the preset resolution. Pixel values of pixel points with the same coordinates in the plurality of third feature maps (for example, parameters such as a RGB value or a depth value) can be averaged, and pixel values of pixel points with the same coordinates in the fourth feature map can be obtained. In this way, pixel values of all pixel points in the fourth feature map can be determined, i.e., the fourth feature map can be obtained, wherein the fourth feature map is a feature map with equalized features.

In a possible implementation, a feature extraction can be performed on a fourth feature map to obtain a second feature map. In an example, the feature extraction may be performed on the fourth feature map by using a convolution layer of the equalization subnetwork. For example, the feature extraction is performed on the fourth feature map by using a non-local attention mechanism (Non-Local) to obtain the second feature map, wherein the second feature map is a feature map with equalized features.

In a possible implementation, obtaining the plurality of equalized feature images according to the second feature map and the plurality of first feature maps includes: performing a scaling processing on the second feature map to obtain a fifth feature map corresponding to the each first feature map respectively, wherein the first feature map and the corresponding fifth feature map have the same resolution; and performing a residual connection on the each first feature map and the corresponding fifth feature map respectively to obtain the equalized feature image.

In a possible implementation, the second feature map and each first feature map may have different resolutions, and a scaling processing can be performed on a second feature map to obtain a fifth feature map with the same resolution as that of each first feature map, respectively.

In an example, if the resolution of the second feature map is 800×600, a down-sampling processing such as pooling can be performed on the second feature map to obtain the fifth feature map with a resolution of 640×480, that is, the fifth feature map corresponding to the first feature map with a resolution of 640×480; an up-sampling processing such as interpolation can be performed on the second feature map to obtain the fifth feature map with a resolution of 1024×768, that is, the fifth feature map corresponding to the first feature map with a resolution of 1024×768 . . . . There are no limitations on the resolutions of the second feature map and the first feature map in the present disclosure.

In a possible implementation, the first feature map and the corresponding fifth feature map have the same resolution. A residual connection processing can be performed on the first feature map and the corresponding fifth feature map to obtain the equalized feature image. For example, a pixel value of a pixel point at a certain coordinate in the first feature map can be added to a pixel value of a pixel point at the same coordinate in the corresponding fifth feature map to obtain a pixel value of the pixel point in the equalized feature image. In this way, pixel values of all pixel points in the equalized feature image can be obtained, that is, the equalized feature image is obtained.

By this way, it is possible to obtain a second feature map of feature equalization by an equalization processing, and obtain an equalized feature map by a residual connection, which can reduce the information loss and improve the training effect.

In a possible implementation, in step S12, a target detection can be performed on an equalized feature image by a detection subnetwork to obtain a predicted region of a target object in the equalized feature image. In an example, the predicted region where the target object is located can be box-selected by a selection box. The target detection processing may also be implemented by other neural networks for target detection or other methods to acquire a plurality of predicted regions of the target object. There is no limitation on the implementation of target detection processing in the present disclosure.

In a possible implementation, in step S13, the sample image is a labeled sample image, for example, the region where the target object is located may be labeled, that is, the region where the target object is located is box-selected using a selection box. The equalized feature image is obtained according to the sample image, the position of the region where the target object is located in the equalized feature image can be determined according to the selection box which box-selects the region where the target object is located in the sample image, and the position can be box-selected, the box-selected region being the labeled region. In an example, the labeled region corresponds to the target object, the sample image or the equalized feature image of the sample image may include one or more target objects, and each target object may be labeled, that is, each target object has a corresponding labeled region.

In a possible implementation, the intersection-over-union is an area ratio of an overlapping region to a merged region of a predicted region of a target object and a corresponding labeled region, the overlapping region between the predicted region and the labeled region is an intersection of these two regions, and the merged region of the predicted region and the labeled region is a union of these two regions. In an example, the detection network may separately determine a predicted region of each object. For example, for a target object A, the detection network may determine a plurality of predicted regions of the target object A, and for a target object B, the detection network may determine a plurality of predicted regions of the target object B. When determining the intersection-over-union of a predicted region, an area ratio of an overlapping region to a merged region of the predicted region and the corresponding labeled region can be determined. For example, when determining the intersection-over-union of a certain predicted region in the target object A, an area ratio of an overlapping region to a merged region of the predicted region and a labeled region of the target object A can be determined.

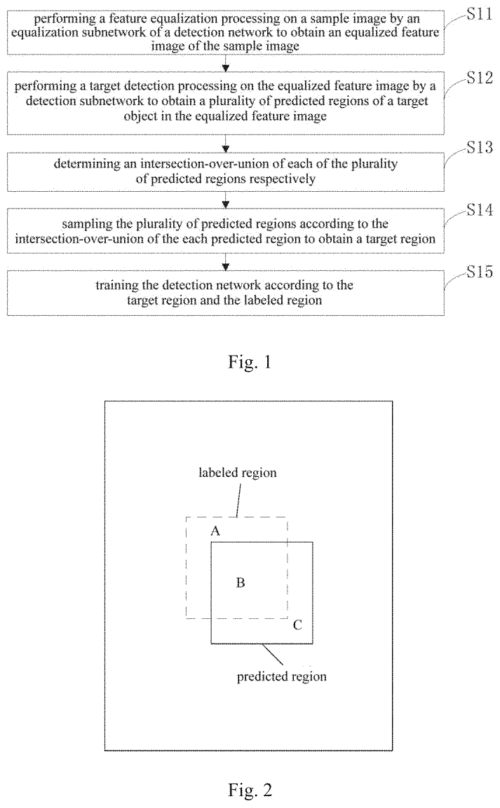

FIG. 2 shows a schematic diagram of an intersection-over-union of a predicted region according to embodiments of the present disclosure. As shown in FIG. 2, in a certain equalized feature image, a region in which a target object is located has been labeled, and the label may be a selection box which box-selects the region in which the target object is located, for example, the labeled region shown by a dotted line in FIG. 2. Target detection methods can be used to detect target objects in an equalized feature image, for example, methods such as a detection network can be used to perform such detection, and a predicted region of the detected target object, for example, a predicted region shown by a solid line in FIG. 2, can be box-selected. As shown in FIG. 2, the labeled region is A+B, the predicted region is B +C, the overlapping region between the predicted region and the labeled region is B, and the merged region between the predicted region and the labeled region is A+B+C. The intersection-over-union of the sample image is the area ratio of the area of region B to the area of region A+B+C.

In a possible implementation, the intersection-over-union is positively correlated with the degree of difficulty in determining a predicted region, that is, the proportion of a predicted region whose determining process is difficult is greater in a predicted region whose intersection-over-union is relatively high. However, in all the predicted regions, the proportion of a predicted region whose intersection-over-union is relatively low is larger. If a random sampling or a uniform sampling is performed directly in all the predicted regions, the probability of obtaining the predicted region whose intersection-over-union is relatively low is larger, that is, the probability of obtaining the predicted region whose determining process is easy is larger. And if a large number of predicted regions whose determining process is easy are used for training, the training efficiency is lower. And in case of using the predicted regions whose determining process is difficult for training, more information can be obtained in each training and the training efficiency can be improved. Therefore, the predicted regions can be screened according to the intersection-over-union of each predicted region, so that in the screened out predicted regions, the proportion of the predicted regions whose determining process is difficult is higher and the training efficiency can be improved.

In a possible implementation, step S14 may include: performing a classification processing on the plurality of predicted regions according to the intersection-over-union of each predicted region to obtain a plurality of categories of predicted regions; and performing a sampling processing on the predicted regions of each category to obtain the target region.

In a possible implementation, the classification processing can be performed on the predicted regions according to the intersection-over-union. For example, the predicted regions with an intersection-over-union greater than 0 and less than or equal to 0.05 can be classified into a category, the predicted regions with an intersection-over-union greater than 0.05 and less than or equal to 0.1 can be classified into a category, and the predicted regions with an intersection-over-union greater than 0.1 and less than or equal to 0.15 can be classified into a category, . . . . That is, the interval length of each category in the intersection-over-union is 0.05. There is no limitation on the number of categories and the interval length of each category in present disclosure.

In a possible implementation, a uniform sampling or a random sampling can be performed in each category to obtain the target region. That is, the predicted regions are extracted in both the category with a relatively high intersection-over-union and the category with a relative low intersection-over-union, so as to increase the probability of extracting the predicted region with a relatively high intersection-over-union, i.e., increase the proportion of the predicted regions whose determining process is difficult in the target region. In each category, the probability of the predicted region being extracted can be expressed by the following formula (1):

$${p}_{k} = \frac{N}{K} \times \frac{1}{{M}_{k}} \qquad ( 1 )$$

wherein, K (K is an integer greater than 1) is the number of categories, pₖ is the probability of the predicted region being extracted in the k^{th} (k is a positive integer less than or equal to K) category, N is the total number of predicted region images, and Mₖ is the number of predicted regions in the k^{th} category.

In an example, a predicted region with an intersection-over-union higher than a preset threshold (e.g., 0.05, 0.1, etc.) or a predicted region with an intersection-over-union belonging to a preset interval (e.g., greater than 0.05 and less than or equal to 0.5, etc.) may also be screened out, as the target region. There is no limitation on the method of screening in the present disclosure.

By this way, it is possible to perform classification on the predicted regions by the intersection-over-union, and perform sampling on the predicted regions of each category. It is possible to increase the probability of extracting the predicted regions with a relative high intersection-over-union, increase the proportion of the predicted regions whose determining process is difficult in the target region, and improve the training efficiency.

In a possible implementation, in step S15, the detection network may be a neural network used to detect a target object in an image, for example, the detection network may be a convolutional neural network, and there is no limitation on the type of detection network in the present disclosure. Target regions and labeled regions in the equalized feature images can be used to train the detection network.

In a possible implementation, training the detection network according to the target region and the labeled region includes: determining an identification loss and a location loss of the detection network according to the target region and the labeled region; adjust network parameters of the detection network according to the identification loss and the location loss; and obtaining the trained detection network when training conditions are satisfied.

In a possible implementation, the identification loss and the location loss may be determined by any one of the target region and the labeled region, wherein the identification loss is used to indicate whether the neural network identifies the target object correctly. For example, the equalized feature image may include a plurality of objects, of which only one or a part of the objects is the target object, and the objects may be classified into two categories (the object is the target object and the object is not the target object). In an example, a probability can be used to represent the identification result, for example, the probability that a certain object is the target object. That is, if the probability that a certain object is the target object is greater than or equal to 50%, the object is the target object; otherwise, the object is not the target object.

In a possible implementation, the identification loss of the detection network can be determined according to the target region and the labeled region. In an example, the region in the selection box which box-selected the region where the target object predicted by the detection network is located is the target region. For example, the image includes a plurality of objects, in which the region where the target object is located may be box-selected, while other objects may not be box-selected. The identification loss of the detection network may be determined according to a similarity between the object box-selected by the target region and the target object. For example, the probability of the object in the target region being the target object is 70% (that is, the detection network determines that the similarity between the object in the target region and the target object is 70%), and if such object is the target object, the probability can be labeled as 100%. Therefore, the identification loss can be determined according to an error of 30%.

In a possible implementation, the location loss of the detection network is determined according to the target region and the labeled region. In an example, the labeled region is a selection box which box-selects the region where the target object is located. That is, the detection network for the target region predicts the region where the target object is located and box-selects this region using the selection box. The location loss can be determined by comparing the position, size, and so on of the above two selection boxes.

In a possible implementation, determining the identification loss and the location loss of the detection network according to the target region and the labeled region includes: determining a position error between the target region and the labeled region; and determining the location loss according to the position error when the position error is less than a preset threshold. Both the predicted region and the labeled region are selection boxes, and the predicted region can be compared with the labeled region. The position error may include errors in the position and size of the selection box, such as errors in the coordinates of the center point or the vertex of the upper left corner of the selection box and errors in the length and width of the selection box. If the prediction on the target object is correct, the position error is smaller. In the training process, the location loss determined by using the position error can be conductive to the convergence of location loss, improve the training efficiency, and improve the goodness-of-fit of the detection network. If the prediction on the target object is incorrect, for example, mistaking a certain non-target object as the target object, the position error is larger. In the training process, the location loss is not easy to converge, and the training process is inefficient, which is not conducive to improve the goodness-of-fit of the detection network. Therefore, a preset threshold can be used to determine the location loss. When the position error is less than the preset threshold, the prediction on the target region can be regarded as correct, and the location loss can be determined according to the position error.

In a possible implementation, determining the identification loss and the location loss of the detection network according to the target region and the labeled region includes: determining a position error between the target region and the labeled region; and determining the location loss according to preset value when the position error is greater than or equal to a preset threshold. In an example, if the position error is greater than or equal to the preset threshold, the prediction on the target object may be regarded as incorrect, and the location loss may be determined according to a preset value (e.g., a certain constant value) to reduce the gradient of the location loss during the training process, thereby accelerating the convergence of the location loss and improving the training efficiency.

In a possible implementation, the location loss can be determined by the following formula (2):

$$\frac{\partial {L}_{pro}}{\partial x} = \{ \begin{matrix}α ln ( b \vert x \vert + 1 ) & \vert x \vert < ɛ \\ γ & \vert x \vert \geq ɛ\end{matrix} \qquad ( 2 )$$

wherein, Lₚᵣₒ is the location loss, α and b are the set parameters, x is the position error, γ is the preset value, and ε is the preset threshold. In an example, ε=1, and γ=αln(b+1). There is no limitation on the values of α, b and γ in the present disclosure.

The location loss Lₚᵣₒ can be obtained by integrating formula (2), and Lₚᵣₒ can be determined according to the following formula (3):

$${L}_{pro} = \{ \begin{matrix}\frac{a}{b} ( b \vert x \vert + 1 ) ln ( b \vert x \vert + 1 ) - α \vert x \vert & \vert x \vert < ɛ \\ γ \vert x \vert + C & \vert x \vert \geq ɛ\end{matrix} \qquad ( 3 )$$

wherein, C is an integral constant. In formula (3), if the position error is less than the preset threshold, that is, the prediction on the target object is correct, the gradient of the location loss is improved by logarithm, so that the gradient of adjusting parameters by the location loss during the training process becomes larger, thereby improving the training efficiency and improving the goodness-of-fit of the detection network. If the prediction on the target object is incorrect, the location loss is a constant γ, which reduces the gradient of the location loss, reduces the influence of the location loss on the training process, so as to accelerate the convergence of the location loss and improve the goodness-of-fit of the detection network.

In a possible implementation, network parameters of the detection network may be adjusted according to the identification loss and the location loss. In an example, a comprehensive network loss of the detection network may be determined according to the identification loss and the location loss. For example, the comprehensive network loss of the detection network may be determined by the following formula (4):

L=Lₚᵣₒ+L_{cls} (4)

wherein, L is the comprehensive network loss, and L_{cls} is the identification loss.

In a possible implementation, the network parameters of the detection network can be adjusted in a direction that minimizes the comprehensive network loss. In an example, the network parameters of the detection network can be adjusted by backward propagation of the comprehensive network loss by using a gradient descent method.

In a possible implementation, training conditions may include conditions such as the number of adjustments and the size or convergence and divergence of the comprehensive network loss. The detection network can be adjusted for a predetermined number of times. When the number of adjustments reaches the predetermined number of times, the training condition is satisfied. The number of trainings may not be limited. When the comprehensive network loss is reduced to a certain degree or converges within a certain interval, the training condition is satisfied. After the training is completed, the detection network can be used in the process of detecting the target object in the image.

By this way, it is possible to increase the gradient of the location loss, improve the training efficiency, and improve the goodness-of-fit of the detection network when the prediction on the target object is correct. And when the prediction on the target object is incorrect, it is possible to reduce the gradient of the location loss, reduce the influence of location loss on the training process, so as to accelerate the convergence of location loss and improve the training efficiency.

In a possible implementation, according to embodiments of the present disclosure, an image processing method is further provided which comprises: inputting an image to be detected into a trained detection network for processing to obtain position information of a target object.

In a possible implementation, the image to be detected is an image including a target object, and a feature equalization processing can be performed on the image to be detected by the equalization subnetwork of the detection network to obtain a set of equalized feature map.

In a possible implementation, the equalization feature map can be input into the detection subnetwork of the detection network, the detection subnetwork can identify the target object, determine the position of the target object, and obtain the position information of the target object, for example, the selection box which box-selects the target object.

According to the image processing method of the embodiments of the present disclosure, it is possible to obtain the second feature map of feature equalization by the equalization processing and obtain the equalized feature map by the residual connection, which can reduce the information loss, improve the training effect, and improve the detection accuracy of the detection network. It is possible to classify the predicted regions by the intersection-over-union and sample the predicted regions of each category, which can improve the probability of extracting the predicted regions with higher intersection-over-unions, improve the proportion of predicted region whose determining process is difficult in the predicted regions, improve the training efficiency, and reducing the memory consumption and resource occupation. Further, it is possible to improve the gradient of location loss, improve the training efficiency, and improve the goodness-of-fit of the detection network when the prediction on the target object is correct, and when the prediction on the target object is incorrect, it is possible to reduce the gradient of location loss and reduce the influence of location loss on the training process so as to accelerate the convergence of location loss and improve the training efficiency.

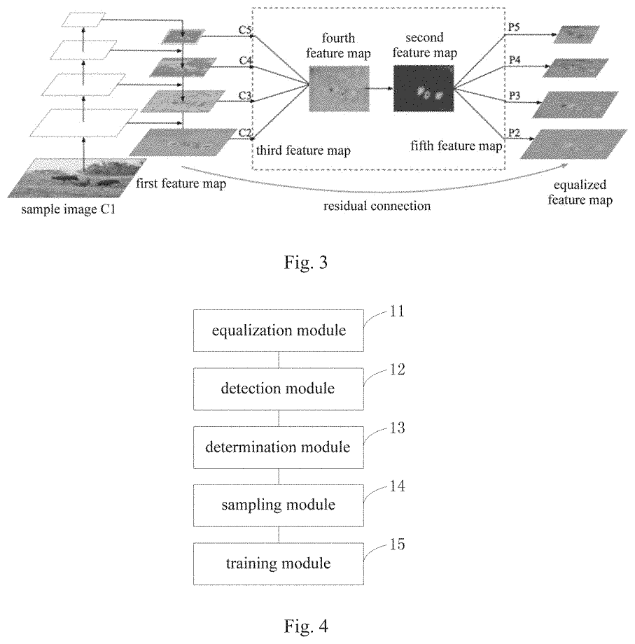

FIG. 3 shows a schematic diagram of an application of an image processing method according to embodiments of the present disclosure. As shown in FIG. 3, a plurality of levels of convolution layers of an equalization subnetwork of a detection network may be used to perform a feature extraction on a sample image Cl to obtain a plurality of first feature maps with different resolutions, for example, to obtain first feature maps with resolutions of 640×480, 800×600, 1024×768, 1600×1200, etc.

In a possible implementation, a scaling processing can be performed on each of the first feature maps to obtain a plurality of third feature maps with preset resolutions. For example, the scaling processing may be separately performed on the first feature maps with resolutions of 640×480, 800×600, 1024×768, and 1600×1200 to obtain third feature maps with resolutions of 800×600, respectively.

In a possible implementation, an average processing can be performed on a plurality of third feature maps to obtain a fourth feature map with equalized features. And a feature extraction is performed on the fourth feature map by using a non-local attention mechanism (Non-Local) to obtain the second feature map.

In a possible implementation, a scaling processing can be performed on the second feature map to obtain fifth feature maps (e.g., C2, C3, C4, C5) with the same resolution as that of each of the first feature maps. For example, the second feature maps may be respectively scaled to the fifth feature maps (e.g., P2, P3, P4, P5) with resolutions of 640×480, 800×600, 1024×768, 1600×1200, etc.

In a possible implementation, a residual connection processing can be performed on the first feature map and the corresponding fifth feature map, that is, parameters such as RGB values or gray values of the pixel points with the same coordinates in the first feature map and the corresponding fifth feature map are added to obtain a plurality of equalized feature maps.

In a possible implementation, a target detection processing can be performed on the equalized feature image by using a detection subnetwork of a detection network to obtain a plurality of predicted regions of a target object in the equalized feature image. Intersection-over-unions of the plurality of predicted regions can be determined respectively, the predicted regions can be classified according to the intersection-over-union, and the predicted regions of each category can be sampled. Accordingly, a target region can be obtained in which the proportion of the predicted regions whose determining process is difficult is larger.

In a possible implementation, the detection network can be trained using the target region and the labeled region, that is, the identification loss is determined based on the similarity between the object box-selected by the target region and the target object, and the location loss is determined based on the target region and labeled region and formula (3). Further, the comprehensive network loss may be determined by formula (4), and the network parameters of the detection network may be adjusted according to the comprehensive network loss. When the comprehensive network loss meets the training condition, training is completed, and the target object in the image to be detected may be detected by using the trained detection network.

In a possible implementation, a feature equalization processing may be performed on an image to be detected by using an equalization subnetwork, and the obtained equalized feature map is inputted into a detection subnetwork of a detection network to obtain the position information of the target object.

In an example, the detection network can be used in automatic driving to perform target detection. For example, obstacles, traffic lamps or traffic signs can be detected, which can provide a basis for controlling the operation of a vehicle. In an example, the detection network can be used for security surveillance and can detect target people in the surveillance video. In an example, the detection network may also be used to detect target objects in remote sensing images or navigation videos for example, and there is no limitation on the field of application of the detection network in the present disclosure.

FIG. 4 shows a block diagram of an image processing device according to embodiments of the present disclosure. As shown in FIG. 4, the device comprise:

an equalization module 11 configured to perform a feature equalization processing on a sample image by an equalization subnetwork of a detection network to obtain an equalized feature image of the sample image, the detection network including the equalization subnetwork and a detection subnetwork; a detection module 12 configured to perform a target detection processing on the equalized feature image by the detection subnetwork to obtain a plurality of predicted regions of a target object in the equalized feature image; a determination module 13 configured to separately determine an intersection-over-union of each of the plurality of predicted regions, wherein the intersection-over-union is an area ratio of an overlapping region to a merged region of a predicted region of the target object and a corresponding labeled region in the sample image; a sampling module 14 configured to sample the plurality of predicted regions according to the intersection-over-union of each of the predicted regions to obtain a target region; and a training module 15 configured to train the detection network according to the target region and the labeled region.

In a possible implementation, the sampling module is further configured to: perform a classification processing on the plurality of predicted regions according to the intersection-over-union of each of the predicted regions to obtain a plurality of categories of predicted regions; and perform a sampling processing on the predicted regions of each category respectively to obtain the target region.

In a possible implementation, the equalization module is further configured to: perform a feature extraction processing on the sample image to obtain a plurality of first feature maps, wherein a resolution of at least one of the plurality of first feature maps is different from those of other first feature maps; perform an equalization processing on the plurality of first feature maps to obtain a second feature map; and obtain a plurality of equalized feature images according to the second feature map and the plurality of first feature maps.

In a possible implementation, the equalization module is further configured to: separately perform a scaling processing on the plurality of first feature maps to obtain a plurality of third feature maps with preset resolutions; perform an average processing on the plurality of third feature maps to obtain a fourth feature map; and perform a feature extraction processing on the fourth feature map to obtain the second feature map.

In a possible implementation, the equalization module is further configured to: perform a scaling processing on the second feature map to obtain a fifth feature map corresponding to the each first feature map respectively, wherein the first feature map has the same resolution as the corresponding fifth feature map; and perform a residual connection on the each first feature map and the corresponding fifth feature map to obtain the equalized feature image.

In a possible implementation, the training module is further configured to: determine an identification loss and a location loss of the detection network according to the target region and the labeled region; adjust network parameters of the detection network according to the identification loss and the location loss; and obtain the trained detection network when training conditions are satisfied.

In a possible implementation, the training module is further configured to: determine a position error between the target region and the labeled region; and determine the location loss according to the position error when the position error is less than a preset threshold.

In a possible implementation, the training module is further configured to: determine a position error between the target region and the labeled region; and determine the location loss according to a preset value when the position error is larger than the preset threshold.

In a possible implementation, according to the embodiments of the present disclosure, an image processing device is further provided, the device comprising: an obtaining module configured to input an image to be detected into the detection network trained by the image processing device for processing, so as to obtain position information of a target object.

It can be understood that, the foregoing various method embodiments mentioned in the present disclosure, without violating the principle and logic, may be combined with each other to form a combined embodiment. Due to the limited space, details thereof are not described herein again.

In addition, the present disclosure also provides an image processing device, an electronic apparatus, a computer readable storage medium, and a program, all of which can be used to implement any of the image processing methods provided in the present disclosure. For the corresponding technical solutions and descriptions, please refer to the corresponding description in the method section, which are not repeated herein again.

A person skilled in the art can understand that in the foregoing methods of a specific implementation, the order of execution of each step does not mean a strict order of execution, but constitutes any limitation on the implementation process. The order of execution of each step shall be determined by its function and possible internal logic.

In some embodiments, the functions possessed by or modules contained in the device provided in embodiments of the present disclosure can be used to execute the methods described in the foregoing method embodiments. The specific implementation thereof can refer to the above descriptions on method embodiments, and will not be repeated herein again for the sake of brevity.

Embodiments of the present disclosure further provides a computer readable storage medium having computer program instructions stored thereon, which when executed by a processor, implement the foregoing method. A computer readable storage medium may be a non-volatile computer readable storage medium.

Embodiments of the present disclosure further provide an electronic apparatus comprising: a processor; and a memory for storing processor executable instructions, wherein the processor is configured to execute the forgoing method.

The electronic apparatus can be provided as a terminal, server, or other form of device.

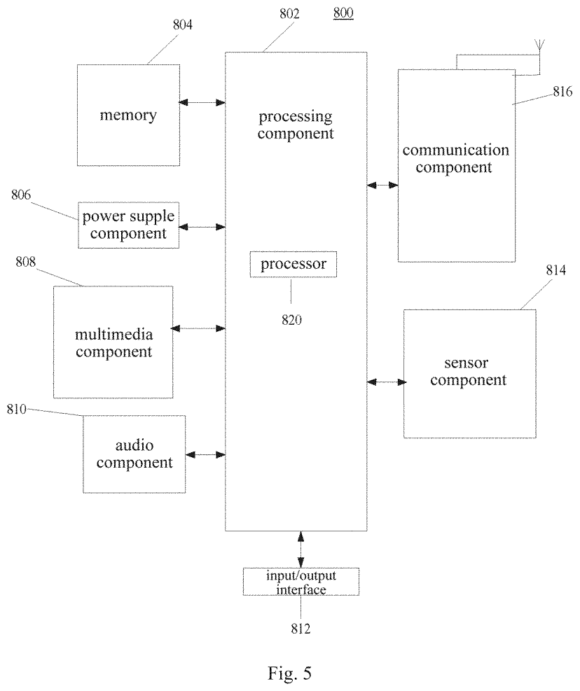

FIG. 5 is a block diagram of an electronic apparatus 800 according to an exemplary embodiment. For example, the electronic apparatus 800 can be terminals such as a mobile phone, a computer, a digital broadcast terminal, a messaging apparatus, a game console, a tablet apparatus, a medical apparatus, a fitness equipment, a personal digital assistant, and so on.

Referring to FIG. 5, the electronic apparatus 800 can include one or more of the following components: a processing component 802, a memory 804, a power supply component 806, a multimedia component 808, an audio component 810, an input/output (I/O) interface 812, a sensor component 814, and a communication component 816.

The processing component 802 typically controls the overall operation of the electronic apparatus 800, such as operations associated with displays, telephone calls, data communications, camera operations, and recording operations. The processing component 802 may include one or more processors 820 to execute instructions so as to complete all or part of the steps of the method described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operation at the electronic apparatus 800. Examples of these data include instructions for any application or method to operate on the electronic apparatus 800, contact data, phone directory data, messages, pictures, videos, and the like. The memory 804 may be implemented by any type of volatile or non-volatile memory device or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 806 provides power to various components of the electronic apparatus 800. The power supply component 806 may include a power supply management system, one or more power supplies, and other components associated with generating, managing, and distributing power for the electronic apparatus 800.

The multimedia component 808 includes a screen that provides an output interface between the electronic apparatus 800 and the user. In some embodiments, the screen may include a liquid crystal display (LCD) and a touch panel (TP). If the screen includes a touch panel, the screen can be implemented as a touchscreen to receive input signals from the user. The touch panel includes one or more touch sensors to sense touches, slides, and gestures on the touch panel. The touch sensor can sense not only the boundary of the touch or slide action but also the duration and pressure associated with the touch or slide operation. In some embodiments, the multimedia component 808 includes a front and/or rear camera. When the electronic apparatus 800 is in an operation mode, such as a shooting mode or a video mode, the front and/or rear camera may receive external multimedia data. Each front and rear cameras may be a fixed optical lens system or have focal length and optical zoom capability.

The audio component 810 is configured to output and/or input audio signals. For example, the audio component 810 includes a microphone (MIC) that is configured to receive external audio signals when the electronic apparatus 800 is in an operation mode, such as call mode, recording mode, and speech recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and peripheral interface modules, which may be a keyboard, a tap wheel, a button, and so on. These buttons may include but are not limited to: a home button, a volume button, a start button, and a lock button.

The sensor component 814 includes one or more sensors for providing the electronic apparatus 800 with various aspects of state assessment. For example, the sensor component 814 may detect an on/off state of the electronic apparatus 800 and a relative positioning of the component, for example, the component being the display and keypad of the electronic apparatus 800. The sensor component 814 may also detect a change in position of the electronic apparatus 800 or one component of the electronic apparatus 800, the presence or absence of user contact with the electronic apparatus 800, the orientation or acceleration/deceleration of the electronic apparatus 800, and the temperature change of the electronic apparatus 800. The sensor component 814 may include a proximity sensor configured to detect the presence of a nearby object without any physical contact. The sensor component 814 may also include light sensors, such as CMOS or CCD image sensors, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the electronic apparatus 800 and other apparatus. The electronic apparatus 800 can access wireless networks based on communication standards, such as WiFi, 2G or 3G, or a combination thereof. In an exemplary embodiment, the communication component 816 receives broadcast signals or broadcast-related information from an external broadcast management system via a broadcast channel. In an exemplary embodiment, the communication component 816 further includes a near field communication (NFC) module to facilitate a short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the electronic apparatus 800 may be implemented by one or more application specific integrated circuits (ASICs), digital signal processors (DSPs), digital signal processing devices (DSPD), programmable logic devices (PLDs), field programmable gate arrays (FPGAs), controllers, microcontrollers, microprocessors, or other electronic components for performing the method described above.

In an exemplary embodiment, there is also provided a non-volatile computer readable storage medium, such as a memory 804 including computer program instructions, which may be executed by the processor 820 of the electronic apparatus 800 to complete the method described above.

Embodiments of the present disclosure further provide a computer program product including computer readable codes, and when the computer readable codes are run on an apparatus, a processor in the apparatus executes instructions for implementing the method provided in any of the foregoing embodiments.

The computer program product may be specifically implemented by hardware, software, or a combination thereof. In an optional embodiment, the computer program product is specifically embodied as a computer storage medium. In another optional embodiment, the computer program product is specifically embodied as a software product, such as a Software Development Kit (SDK).

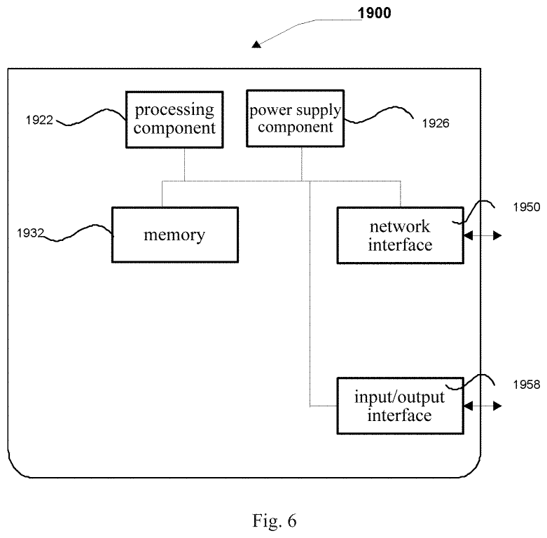

FIG. 6 is a block diagram of an electronic apparatus 1900 according to an exemplary embodiment. For example, the electronic apparatus 1900 may be provided as a server. Referring to FIG. 6, the electronic apparatus 1900 includes a processing component 1922 which further includes one or more processors and memory resources represented by a memory 1932 for storing instructions, such as applications, that can be executed by the processing component 1922. The application program stored in the memory 1932 may include one or more above modules each of which corresponds to a set of instructions. In addition, the processing component 1922 is configured to execute instructions to execute the above method.

The electronic apparatus 1900 may further include a power supply component 1926 configured to perform power management of the electronic apparatus 1900, a wired or wireless network interface 1950 configured to connect the electronic apparatus 1900 to the network, and an input/output (I/O) interface 1958. The electronic apparatus 1900 may operate based on an operating system stored in the memory 1932, such as Windows Server™, Mac OS X™, Unix™ Linux™, FreeBSD™, or the like.

In an exemplary embodiment, there is also provided a non-volatile computer readable storage medium, such as a memory 1932 including computer program instructions that may be executed by the processing component 1922 of the electronic apparatus 1900 to complete the foregoing method.

The present disclosure may be a system, a method, and/or a computer program product. The computer program product may include a computer readable storage medium having computer readable program instructions for causing a processor to carry out the aspects of the present disclosure loaded thereon.

The computer readable storage medium may be a tangible apparatus that can retain and store instructions used by an instruction executing apparatus. The computer readable storage medium may be, but not limited to, e.g., electronic storage apparatus, magnetic storage apparatus, optical storage apparatus, electromagnetic storage apparatus, semiconductor storage apparatus, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded apparatus (for example, punch-cards or raised structures in a groove having instructions recorded thereon), and any proper combination thereof. A computer readable storage medium referred herein should not be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing apparatuses from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium in the respective computing/processing apparatuses.

Computer program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, apparatus (systems), and computer program product according to the embodiments of the present disclosure. It will be appreciated that each block in the flowchart and/or the block diagram and combinations of blocks in the flowchart and/or block diagram can be implemented by the computer readable program instructions.

These computer readable program instructions may be provided to a processor of a general-purpose computer, a dedicated computer, or other programmable data processing devices, to produce a machine, such that the instructions create a means for implementing the functions/operations specified in one or more blocks in the flowchart and/or block diagram when executed by the processor of the computer or other programmable data processing devices. These computer readable program instructions may also be stored in a computer readable storage medium, wherein the instructions cause a computer, a programmable data processing apparatus and/or other apparatuses to function in a particular manner, such that the computer readable storage medium having instructions stored therein comprises a product that includes instructions implementing aspects of the functions/operations specified in one or more blocks in the flowchart and/or block diagram.

The computer readable program instructions may also be loaded onto a computer, other programmable data processing apparatuses, or other apparatuses to have a series of operational steps performed on the computer, other programmable data processing apparatuses or other apparatuses, so as to produce a computer implemented process, such that the instructions executed on the computer, other programmable data processing apparatuses or other apparatuses implement the functions/operations specified in one or more blocks in the flowchart and/or block diagram.

The flowcharts and block diagrams in the drawings illustrate the architecture, function, and operation that may be implemented by the system, method, and computer program product according to the various embodiments of the present disclosure. In this regard, each block in the flowchart or block diagram may represent a part of modules, program segments, or instructions, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart and combinations of blocks in the block diagram and/or flowchart can be implemented by dedicated hardware-based systems performing the specified functions or operations, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
performing a feature equalization processing on a sample image by an equalization subnetwork of a detection network to obtain an equalized feature image of the sample image, the detection network including the equalization subnetwork and a detection subnetwork;
performing a target detection processing on the equalized feature image by the detection subnetwork to obtain a plurality of predicted regions of a target object in the equalized feature image;
determining an intersection-over-union of each of the plurality of predicted regions respectively, wherein the intersection-over-union is an area ratio of an overlapping region to a merged region of a predicted region of the target object and a corresponding labeled region in the sample image;
sampling the plurality of predicted regions according to the intersection-over-union of each of the predicted regions to obtain a target region; and
training the detection network according to the target region and the labeled region.

2. The method according to claim 1, wherein sampling the plurality of predicted regions according to the intersection-over-union of each of the predicted regions to obtain the target region comprises:
performing a classification processing on the plurality of predicted regions according to the intersection-over-union of each of the predicted regions to obtain a plurality of categories of predicted regions; and
performing a sampling processing on the predicted regions of each category respectively to obtain the target region.

3. The method according to claim 1, wherein performing the feature equalization processing on the sample image by the equalization subnetwork of the detection network to obtain the equalized feature image comprises:
performing a feature extraction processing on the sample image to obtain a plurality of first feature maps, wherein a resolution of at least one of the plurality of first feature maps is different from those of other first feature maps;
performing an equalization processing on the plurality of first feature maps to obtain a second feature map; and
obtaining a plurality of equalized feature images according to the second feature map and the plurality of first feature maps.

4. The method according to claim 3, wherein performing the equalization processing on the plurality of first feature maps to obtain the second feature map comprises:
performing a scaling processing on the plurality of first feature maps respectively to obtain a plurality of third feature maps with preset resolutions;
performing an average processing on the plurality of third feature maps to obtain a fourth feature map; and
performing a feature extraction processing on the fourth feature map to obtain the second feature map.

5. The method according to claim 3, wherein obtaining the plurality of equalized feature images according to the second feature map and the plurality of first feature maps comprises:
performing a scaling processing on the second feature map to obtain a fifth feature map corresponding to the each first feature map respectively, wherein the first feature map has the same resolution as that of the corresponding fifth feature map; and
performing a residual connection on the each first feature map and the corresponding fifth feature map respectively to obtain the equalized feature image.

6. The method according to claim 1, wherein training the detection network according to the target region and the labeled region comprises:
determining an identification loss and a location loss of the detection network according to the target region and the labeled region;
adjusting network parameters of the detection network according to the identification loss and the location loss; and
obtaining the trained detection network when training conditions are satisfied.

7. The method according to claim 6, wherein determining the identification loss and the location loss of the detection network according to the target region and the labeled region comprises:
determining a position error between the target region and the labeled region; and
determining the location loss according to the position error when the position error is less than a preset threshold.

8. The method according to claim 6, wherein determining the identification loss and the location loss of the detection network according to the target region and the labeled region comprises:
determining a position error between the target region and the labeled region; and
determining the location loss according to a preset value when the position error is larger than or equal to a preset threshold.

9. The method according to claim 1, further comprising:
inputting an image to be detected into the trained detection network for processing, so as to obtain a position information of the target object.

10. An image processing device comprising:
a processor; and
a memory configured to store processor executable instructions,
wherein the processor is configured to:
perform a feature equalization processing on a sample image by an equalization subnetwork of a detection network to obtain an equalized feature image of the sample image, the detection network including the equalization subnetwork and a detection subnetwork;
perform a target detection processing on the equalized feature image by the detection subnetwork to obtain a plurality of predicted regions of a target object in the equalized feature image;
determine an intersection-over-union of each of the plurality of predicted regions respectively, wherein the intersection-over-union is an area ratio of an overlapping region to a merged region of a predicted region of the target object and a corresponding labeled region in the sample image;
sample the plurality of predicted regions according to the intersection-over-union of each of the predicted regions to obtain a target region; and
train the detection network according to the target region and the labeled region.

11. The device according to claim 10, wherein sampling the plurality of predicted regions according to the intersection-over-union of each of the predicted regions to obtain the target region comprises:
performing a classification processing on the plurality of predicted regions according to the intersection-over-union of each of the predicted regions to obtain a plurality of categories of predicted regions; and
performing a sampling processing on the predicted regions of each category respectively to obtain the target region.

12. The device according to claim 10, wherein performing the feature equalization processing on the sample image by the equalization subnetwork of the detection network to obtain the equalized feature image of the sample image comprises:
performing a feature extraction processing on the sample image to obtain a plurality of first feature maps, wherein a resolution of at least one of the plurality of first feature maps is different from those of other first feature maps;
performing an equalization processing on the plurality of first feature maps to obtain a second feature map; and
obtaining a plurality of equalized feature images according to the second feature map and the plurality of first feature maps.

13. The device according to claim 12, wherein performing the equalization processing on the plurality of first feature maps to obtain the second feature map comprises:
performing a scaling processing on the plurality of first feature maps respectively to obtain a plurality of third feature maps with preset resolutions;
performing an average processing on the plurality of third feature maps to obtain a fourth feature map; and
performing a feature extraction processing on the fourth feature map to obtain the second feature map.

14. The device according to claim 12, wherein obtaining the plurality of equalized feature images according to the second feature map and the plurality of first feature maps comprises:
performing a scaling processing on the second feature map to obtain a fifth feature map corresponding to the each first feature map respectively, wherein the first feature map has the same resolution as that of the corresponding fifth feature map; and
performing a residual connection on the each first feature map and the corresponding fifth feature map respectively to obtain the equalized feature image.

15. The device according to claim 10, wherein training the detection network according to the target region and the labeled region comprises:
determining an identification loss and a location loss of the detection network according to the target region and the labeled region;
adjusting network parameters of the detection network according to the identification loss and the location loss; and
obtaining the trained detection network when training conditions are satisfied.

16. The device according to claim 15, wherein determining the identification loss and the location loss of the detection network according to the target region and the labeled region comprises:
determining a position error between the target region and the labeled region; and
determining the location loss according to the position error when the position error is less than a preset threshold.

17. The device according to claim 15, wherein determining the identification loss and the location loss of the detection network according to the target region and the labeled region comprises:
determining a position error between the target region and the labeled region; and
determining the location loss according to a preset value when the position error is larger than or equal to a preset threshold.

18. The device according to claim 10, wherein the processor is further configured to:
input an image to be detected into the trained detection network for processing, so as to obtain a position information of the target object.

19. A computer readable storage medium having computer program instructions stored thereon, wherein the computer program instructions, when executed by a processor, implement an image processing method, the method comprising:
performing a feature equalization processing on a sample image by an equalization subnetwork of a detection network to obtain an equalized feature image of the sample image, the detection network including the equalization subnetwork and a detection subnetwork;
performing a target detection processing on the equalized feature image by the detection subnetwork to obtain a plurality of predicted regions of a target object in the equalized feature image;
determining an intersection-over-union of each of the plurality of predicted regions respectively, wherein the intersection-over-union is an area ratio of an overlapping region to a merged region of a predicted region of the target object and a corresponding labeled region in the sample image;
sampling the plurality of predicted regions according to the intersection-over-union of each of the predicted regions to obtain a target region; and
training the detection network according to the target region and the labeled region.
